(19) United States
(12) Patent Application Publication
(10) Pub. No.: US 2026/0027931 A1
(43) Pub. Date: Jan. 29, 2026

(54) Systems and Methods for Bi-Directional Vehicle to Vehicle Charging

(71) Applicant: Daimler Truck AG, Leinfelden-Echterdingen (DE)

(72) Inventors: Ashish Baban BANSOD, Portland, OR (US); Sathish VIJAYARAGHAVAN, Portland, OR (US); Sashank Mani VEDULA, Portland, OR (US)

(21) Appl. No.: 19/264,767

(22) Filed: Jul. 9, 2025

Related U.S. Application Data
(60) Provisional application No. 63/674,731, filed on Jul. 23, 2024.

(51) Int. Cl. B60L 53/53; B60L 53/62; B60L 53/66; B60L 58/12; H02J 7/00; H02J 7/34

(52) U.S. Cl. CPC B60L 53/53; B60L 53/62; B60L 53/66; B60L 58/12; H02J 7/00032; H02J 7/342; B60L 2210/10; H02J 2207/20

(57) ABSTRACT

The various implementations described herein include methods and devices for bi-directional vehicle-to-vehicle charging. A method is performed at a system having a first communication controller (FCC), a second communication controller (SCC), a primary controller, and a DC-to-DC converter. The method includes transmitting status information regarding the first vehicle and the second vehicle to the primary controller via the first communication controller and the second communication controller, and verifying that a charge transfer process can be performed between the first vehicle and the second vehicle based on the status information. The method further includes designating the first vehicle as a charge donor and the second vehicle as a charge acceptor, automatically initiating transmission of electricity from the first vehicle to the second vehicle, and configuring the DC-to-DC converter to convert electricity from a nominal voltage corresponding to the first vehicle to a second nominal voltage corresponding to the second vehicle.

### RELATED APPLICATIONS

This application claims the benefit of and priority to U.S. Provisional Patent Application No. 63/674,731, filed Jul. 23, 2024, entitled “Systems and Methods for Bi-Directional Vehicle to Vehicle Charging,” which is incorporated by reference herein in its entirety.

### TECHNICAL FIELD

The disclosed implementations relate generally to vehicle charging and more specifically to systems and methods of using a controller to implement vehicle-to-vehicle charging.

### BACKGROUND

Electrical vehicles (EVs) are becoming more prevalent as a mode of transportation. However, the infrastructure to support the operation of EVs has not grown as rapidly as the popularity of EVs. Presently, EVs are commonly charged at private charging stations (e.g., at a home, office, apartment building, or retailer) or at public charging stations that are available to the public (e.g., at public or city parking lots). Just as conventional vehicles need to refuel with gasoline to continue operation, EVs need to regularly recharge their batteries to remain operational. Thus, there is a need to provide accessible charging for EVs.

### SUMMARY

As the popularity of EVs grows, so does the demand for accessible methods of charging EVs. Conventionally, vehicles are refueled at designated locations, such as a gas station, a charging station located in a parking lot, or a personal charging station installed at a home. With the growing demand for EVs comes the need for highly accessible charging options for EVs. An apparatus and method for charging EVs is provided here, where EVs can transmit and receive charge from each other, also referred to as vehicle-to-vehicle charging or V2V charging.

In accordance with some implementations, a method of transferring charge between a first vehicle and a second vehicle is performed at a control system having a first communication controller, a second communication controller that is distinct from the first communication controller, a primary controller, and a DC-to-DC converter. The method includes establishing communication between the first vehicle and the first communication controller, and establishing communication between the second vehicle and the second communication controller. The method further includes, at the first communication controller, receiving first status information for the first vehicle and transmitting the first status information to the primary controller; and at the second communication controller, receiving second status information for the second vehicle and transmitting the second status information to the primary controller. The method also includes verifying, by the primary controller, that the first status information and the second status information meet a predefined set of one or more requirements to perform a charge transfer process between the first vehicle and the second vehicle; and designating (i) the first vehicle as a charge donor vehicle and (ii) the second vehicle as a charge acceptor vehicle. The method further includes, in response to the verifying and designating: (a) automatically configuring, by the primary controller, the DC-to-DC converter to convert electricity from a first nominal voltage to a second nominal voltage; (b) automatically initiating, by the primary controller, transmission of electricity from a battery of the first vehicle to the DC-to-DC converter at the first nominal voltage; and (c) automatically initiating, by the primary controller, transmission of electricity from the DC-to-DC converter to a battery of the second vehicle at the second nominal voltage.

In accordance with some implementations, a control system includes a first communication controller, a second communication controller that is distinct from the first communication controller, a DC-to-DC converter, and a primary controller. The first communication controller is configured to receive first status information for a first vehicle and transmit the first status information to the primary controller. The second communication controller is configured to receive second status information for a second vehicle and transmit the second status information to the primary controller. The second vehicle is distinct from the first vehicle. The primary controller is configured to: (i) verify that the first status information and the second status information meet a predefined set of one or more requirements to perform a charge transfer process between the first vehicle and the second vehicle, (ii) designate the first vehicle as a charge donor vehicle and designate the second vehicle as a charge acceptor vehicle, (iii) automatically configure the DC-to-DC converter to convert electricity from a first nominal voltage to a second nominal voltage, (iv) automatically initiate transmission of electricity from a battery of the first vehicle to the DC-to-DC converter at the first nominal voltage, and (v) automatically initiate transmission of electricity from the DC-to-DC converter to a battery of the second vehicle at the second nominal voltage.

In various circumstances, the vehicle charging apparatus (e.g., control system) and method of the present disclosure has the following advantages over conventional EV charging systems. First, in accordance with some implementations, the disclosed vehicle charging apparatus and methods allows for charging to occur between two electric vehicles, thereby enabling any EV that is enabled to provide a discharge service to act as a mobile charging station (in addition to conventional stationary charging stations). This increases the accessibility of charging opportunities by providing more options for a charging source since any EV capable of providing a discharge service can now be considered as a charge source. This also improves the range of travel for an EV, since EVs can utilize a vehicle-to-vehicle charging scheme to increase the amount of charge enough to get to a stationary charge point. Further, the vehicle charging apparatus and methods described herein utilize a control box, which mediates any communication or information that needs to be shared or coordinated between the two EVs to successfully perform vehicle-to-vehicle charging. Thus, the apparatus and method described herein is compatible with and can be used with any existing EVs, with charging being limited only by the charge donation capability of the EVs, and not limited by differences between the two EVs. In a first example, a charge donor EV may be used as a charge source to provide charging to other EVs regardless of the make, manufacturer, or model of the EV that requires charging. This charge donor EV may periodically return to a stationary source to recharge itself and may travel to the locations of other EVs for on-demand charging. In another example, a first EV may not have enough charge to travel to a charging station. In such cases, a second EV may be able to provide the first EV with enough charge for the first EV to reach a stationary charging station. With the use of the apparatus and method disclosed herein, any two EVs can be connected for a charge transfer process regardless of make, manufacturer, or model. The implementations described above are just two examples in which the vehicle-to-vehicle charging apparatus and methods disclosed herein can be utilized. As the needs and uses for EVs evolve, so will the ways in which new charging technologies such as the one disclosed herein are used.

Thus, methods and systems are disclosed for vehicle-to-vehicle charging. Such methods and systems may complement or replace conventional methods and systems of charging EVs.

### BRIEF DESCRIPTION OF THE DRAWINGS

For a better understanding of the aforementioned systems, methods, and apparatus that provide vehicle-to-vehicle charging, reference should be made to the Description of Implementations below, in conjunction with the following drawings in which like reference numerals refer to corresponding parts throughout the figures.

FIGS. 1A and 1B illustrate an example control system for vehicle-to-vehicle charging in accordance with some implementations.

FIGS. 2A-2C provide a flowchart of a method for vehicle-to-vehicle charging in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

A vehicle-to-vehicle charging system of the present disclosure allows for charge transfer (also referred to as power transfer, electricity transfer, or electrical charge transfer) to be conducted between two different EVs regardless of the compatibility of their communication modules and specifications. In accordance with some implementations, the charging apparatus includes a controller module that can facilitate the charge transfer process (e.g., EV charging process) between two EVs. The apparatus also includes cables that facilitate charge transfer between two EVs. In some implementations, the apparatus facilitates communication (e.g., information transfer) between an EV and the controller module. In some implementations, the apparatus also includes a DC-to-DC converter that can actively modulate the voltage of electricity that is transmitted from one EV to another. In some implementations, the controller module requests information required from each EV to initiate a charge transfer process. The apparatus and method described herein may complement or replace conventional EV charging schemes.

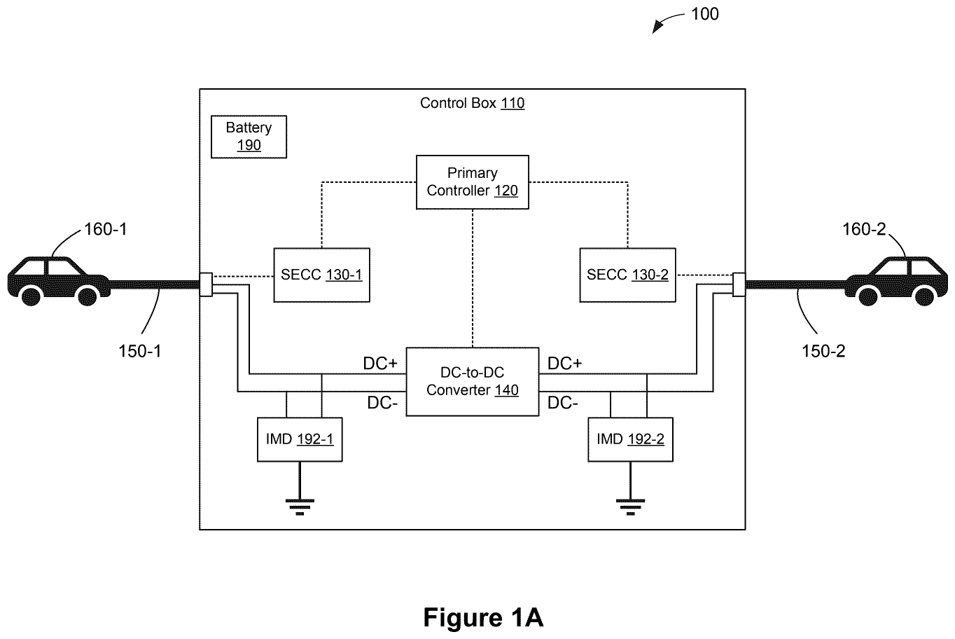

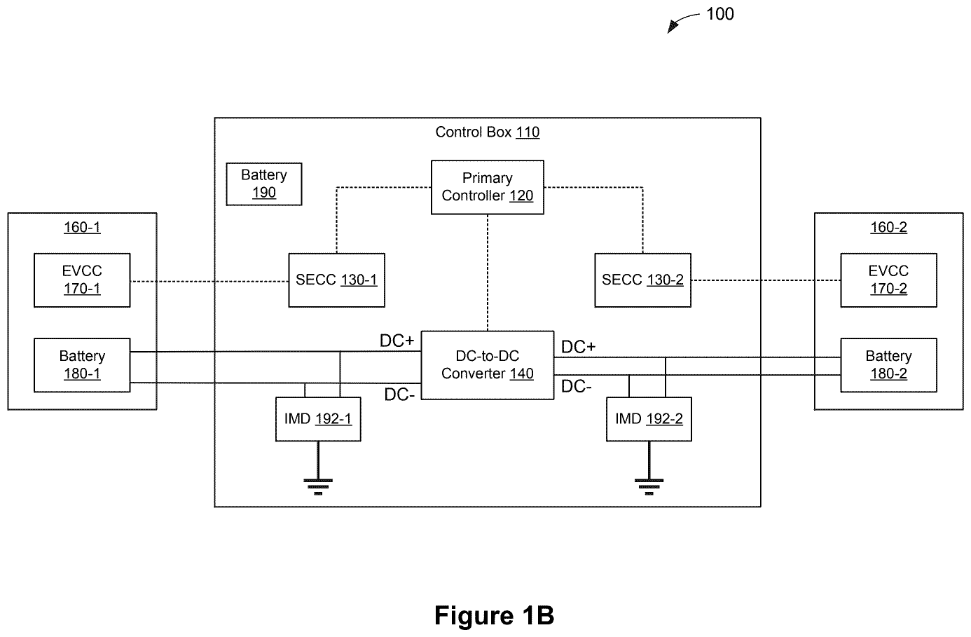

FIGS. 1A and 1B illustrate an example control system 100 (e.g., a vehicle-to-vehicle charging apparatus) for vehicle-to-vehicle charging in accordance with some implementations. Vehicle-to-vehicle charging refers to a process of discharging power (e.g., discharging electricity) from the battery of a first vehicle and transmitting the discharged power from the first vehicle to a second vehicle to charge the battery used by the powertrain of the second vehicle. In some implementations, the power is discharged from a battery that is used for the powertrain of the first vehicle.

The control system 100 includes a control box 110 that houses a primary controller 120, a first supply equipment communication controller (also referred to herein as SECC or communications controller) 130-1, a second SECC 130-2, a bi-directional DC-to-DC converter 140, a low-voltage battery 190, a first isolation monitoring device 192-1 (also referred to herein as IMD), and a second IMD 192-2. The control system 100 also includes a first charging cable 150-1 that is configured to couple to a charging port of an electric vehicle (e.g., EV), and a second charging cable 150-2 that is configured to couple to a charging port of an electric vehicle.

An electric vehicle refers to any vehicle that can operate (e.g., provide power to) its powertrain using electricity and/or any vehicle that can receive charge (e.g., electricity) to power the vehicle's powertrain. Thus, the term electric vehicle refers to any of: an electric-only vehicle (e.g., one that does not utilize other fuel sources such as gasoline or hydrogen), a hybrid vehicle (e.g., one that may utilize other fuel sources in addition to electricity), as well as a vehicle that can receive charge (e.g., electricity) to power the vehicle's powertrain (regardless of what other type of power source(s) the vehicle can utilize to enable its powertrain).

Each of the charging cables 150-1 and 150-2 includes one or more electrical connections (e.g., wires or electrical harness, illustrated in FIG. 1A as a thin solid line) that can connect an electric vehicle to DC-to-DC converter 140. For example, as shown in FIG. 1A, the first charging cable 150-1, when connected to (e.g., plugged into) the first electric vehicle 160-1 (e.g., via a charging port of the first electric vehicle 160-1), is configured to connect the first electric vehicle 160-1 to the DC-to-DC converter 140 so that electricity (i.e., charge, electrical charge, or power) can be transferred between the first electric vehicle 160-1 and the DC-to-DC converter 140. Similarly, the second charging cable 150-2, when connected to (e.g., plugged into) the second electric vehicle 160-2 (e.g., via a charging port of the second electric vehicle 160-2), is configured to connect the second electric vehicle 160-2 to the DC-to-DC converter 140 so that electricity (i.e., charge, electrical charge, or power) can be transferred between the second electric vehicle 160-2 and the DC-to-DC converter 140.

In some implementations, as shown in FIG. 1B, the one or more electrical connections (e.g., wires or electrical harnesses) in each of the charging cables 150-1 and 150-2 that can connect an electric vehicle to the DC-to-DC converter 140, is connected to a battery (e.g., the first battery 180-1 or the second battery 180-2) of an electric vehicle (e.g., the first electric vehicle 160-1 or the second electric vehicle 160-2). For example, the first charging cable 150-1 includes one or more electrical connections (e.g., wires or electrical harnesses) that connect the DC-to-DC converter 140 to the first battery 180-1, which can enable the powertrain of the first electric vehicle 160-1 (e.g., the first power generation battery 180-1 provides power to the powertrain of the first electric vehicle 160-1). Similarly, the second charging cable 150-2 includes one or more electrical connections (e.g., wires or electrical harnesses) that connect the DC-to-DC converter 140 to the second battery 180-2, which can enable the powertrain of the second electric vehicle 160-2 (e.g., the power generation battery 180-2 provides power to the powertrain of the second electric vehicle 160-2).

In some implementations, the first battery is a high voltage battery (e.g., having a voltage that is greater than or equal to any of 100V, 200V, 400V, and 800V). In some implementations, the second battery is a high voltage battery (e.g., having a voltage that is greater than or equal to any of 100V, 200V, 400V, and 800V).

In some implementations, each of the charging cables 150-1 and 150-2 also includes one or more electrical connections (e.g., wires or an electrical harness) that can connect an electric vehicle (e.g., the first electric vehicle 160-1 or the second electric vehicle 160-2) to a supply equipment communication controller SECC 130-1 or 130-2 of the control system 100. For example, as shown in FIG. 1A, the first charging cable 150-1, when connected to (e.g., plugged into) the first electric vehicle 160-1 (e.g., via a charging port of the first electric vehicle 160-1), is configured to connect the first electric vehicle 160-1 to the first SECC 130-1 so that the first SECC 130-1 and the first electric vehicle 160-1 can communicate (e.g., transmit or share information) with one another. Similarly, the second charging cable 150-2, when connected to (e.g., plugged into) the second electric vehicle 160-2 (e.g., via a charging port of the second electric vehicle 160-2), is configured to connect the second electric vehicle 160-2 to the second SECC 130-2 so that the second SECC 130-2 and the second electric vehicle 160-2 can communicate (e.g., transmit or share information) with one another.

In some implementations, as shown in FIG. 1B, the one or more electrical connections (e.g., wires or electrical harnesses) in each of the charging cables 150-1 and 150-2 that connects an electric vehicle to an SECC 130-1 or 130-2 is connected to an electric vehicle communication controller (also referred to herein as EVCC) of the electric vehicle. For example, the first charging cable 150-1 includes one or more electrical connections (e.g., wires or electrical harnesses) that connect the first SECC 130-1 to a first EVCC 170-1 of the first electric vehicle 160-1. Similarly, the second charging cable 150-2 includes one or more electrical connections (e.g., wires or electrical harnesses) that connect the second SECC 130-2 to a second EVCC 170-2 of the second electric vehicle 160-2.

Each of the first SECC 130-1 and the second SECC 130-2 is configured to separately communicate with (e.g., transmit or receive information from) a different electric vehicle, thus omitting the need for the two electric vehicles to communicate directly with one another. This allows two different electric vehicles to engage in vehicle-to-vehicle charging even if the two electric vehicles are not able to communicate with one another. For example, FIG. 1A illustrates a first SECC 130-1 in communication with a first electric vehicle 160-1 and a second SECC 130-2 in communication with a second electric vehicle 160-2. In some implementations, each SECC establishes communication with an electric vehicle via one or more wired connections (e.g., such as one or more electrical connections that are a part of a charging cable such as the charging cables 150-1 or 150-2, illustrated in FIG. 1A as dotted lines). Non-limiting examples of wired connections include: Powerline communication (PLC), Ethernet, controller area network (CAN), and pulse-width modulation (PWM). In some implementations, each SECC communicates with an electric vehicle via wireless communication methods, such as and not limited to, Bluetooth or WiFi connectivity.

Each of the first SECC 130-1 and the second SECC 130-2 is configured to communicate with (e.g., transmit or receive information from) the primary controller 120. For example, the first SECC 130-1 may receive information from the first electric vehicle 160-1 and transmit the information received from the first electric vehicle 160-1 to the primary controller 120. Similarly, the second SECC 130-2 may receive information from the second electric vehicle 160-2 and transmit the information received from the second electric vehicle 160-2 to the primary controller 120.

The primary controller 120 is configured to receive information (e.g., information regarding electric vehicles) from the first SECC 130-1 and the second SECC 130-2. For example, the first SECC 130-1 may request status information regarding the first electric vehicle 160-1. The first electric vehicle 160-1 transmits its status information to the first SECC 130-1 and the first SECC 130-1 transmits (e.g., forwards or shares) the status information for the first electric vehicle 160-1 to the primary controller 120. Similarly, the second SECC 130-2 may request status information regarding the second electric vehicle 160-2. The second electric vehicle 160-2 transmits its status information to the second SECC 130-2 and the second SECC 130-2 transmits (e.g., forwards, shares) the status information for the second electric vehicle 160-2 to the primary controller 120. Status information regarding an electric vehicle may include, but is not limited to, any of the following: the maximum discharge power (e.g., in kilowatts) of the electric vehicle, the minimum discharge power (e.g., in kilowatts) of the electric vehicle, the maximum discharge current (e.g., in amperes) of the electric vehicle, the minimum discharge current (e.g., in amperes) of the electric vehicle, the maximum voltage (e.g., in volts) of the electric vehicle, the minimum voltage (e.g., in volts) of the electric vehicle, the state of charge (e.g., energy, in kilowatt-hours) of the electric vehicle, the voltage of the battery 180-1 of the first vehicle 160-1 and the voltage of the battery 180-2 of the second vehicle 160-2.

In some implementations, the primary controller 120 is configured to designate (e.g., assign) an electric vehicle connected to the control box 110 (via the first charging cable 150-1 or the second charging cable 150-2) as the charge donor vehicle and to designate (e.g., assign) another electric vehicle (e.g., a different vehicle) that is connected to the control box 110 (via the first charging cable 150-1 or the second charging cable 150-2) as the charge acceptor vehicle. In some implementations, the primary controller 120 designates an electric vehicle as the charge acceptor vehicle or the charge donor vehicle based on a comparison of the status of the two vehicles. Following the example provided above, after receiving the status information from the electric vehicles 160-1 and 160-2 via the first SECC 130-1 and the second SECC 130-2, the primary controller 120 may compare two values within the status information of each electric vehicle to each other, such as comparing the state of charge (SoC) of the first electric vehicle 160-1 to the state of charge of the second electric vehicle 160-2. In this example, in response to determining that the state of charge of the first electric vehicle 160-1 is greater than the state of charge of the second electric vehicle 160-2, the primary controller 120 designates the first electric vehicle 160-1 as the charge donor vehicle and designates the second electric vehicle 160-2 as the charge acceptor vehicle. In some implementations, the control box 110 includes one or more user interfaces (e.g., a touch screen, physical or virtual button(s), a switch) that allows a user to designate which vehicle (of the first vehicle 160-1 and the second vehicle 160-2) is a charge donor vehicle and which vehicle (of the first vehicle 160-1 and the second vehicle 160-2) is a charge acceptor vehicle. For example, even though the state of charge of the first electric vehicle 160-1 is greater than the state of charge of the second electric vehicle 160-2, the user may use the one or more user interfaces to designate the first electric vehicle 160-1 as a charge acceptor vehicle and the second electric vehicle 160-2 as the charge donor vehicle to “top off” the first electric vehicle 160-1.

The primary controller 120 is also configured to determine whether an electric vehicle that is connected to the control box 110 via a charging cable (such as the first electric vehicle 160-1 connected via the first charging cable 150-1 and the second electric vehicle 160-2 connected via the second charging cable 150-2) can engage in a vehicle-to-vehicle charging process. In some implementations, the primary controller 120 determines whether two electric vehicles can engage in vehicle-to-vehicle charging by comparing status information received from the electric vehicles (via SECCs that are in communication with the electric vehicles) using a predefined set of one or more requirements. The predefined set of one or more requirements may include one or more of the following: (i) compatibility (e.g., overlap in working range) between the maximum charge/discharge power of a first electric vehicle 160-1 connected to the control box 110 (via the first charging cable 150-1) and the maximum charge/discharge power of the second electric vehicle 160-2 that is also connected to the control box 110 (via the second charging cable 150-2); (ii) compatibility (e.g., overlap in working range) between the minimum charge/discharge power of the first vehicle 160-1 and the minimum charge/discharge power of the second vehicle 160-2; (iii) compatibility (e.g., overlap in working range) between the maximum charge/discharge current of the first vehicle 160-1 and the maximum charge/discharge current of the second vehicle 160-2; (iv) compatibility (e.g., overlap in working range) between the minimum charge/discharge current of the first vehicle 160-1 and the minimum charge/discharge current of the second vehicle 160-2; (v) compatibility (e.g., overlap in working range) between the voltage limits (e.g., maximum voltage and/or minimum voltage) of the first vehicle 160-1 and voltage limits of the DC-to-DC converter 140; and (vi) compatibility (e.g., overlap in working range) between the voltage limits) of the second vehicle 160-2 and the voltage limits of the DC-to-DC converter 140. In some implementations, compatibility between the first vehicle 160-1 and the second vehicle 160-2 require an overlap in working range for one or more of the requirements described above. In some implementations, the one or more requirements include a requirement that the (min, max) voltage ranges of the two vehicles overlap (e.g., there is at least a voltage or range of voltages that works for both vehicles). The predefined set of one or more requirements may also include a requirement for an electric vehicle that has been designated as a charge donor vehicle to support bi-directional power flow (e.g., that the electric vehicle can receive electrical charge and can discharge electrical charge).

In some implementations, comparing status information received from the electric vehicles includes comparing one or more of the following for compatibility: (i) the maximum discharge power of the charge donor vehicle to the maximum charge power of the charge acceptor vehicle; (ii) the minimum discharge power of the charge donor vehicle to the minimum charge power of the charge acceptor vehicle; (iii) the maximum discharge current of the charge donor vehicle to the maximum charge current of the charge acceptor vehicle; (iv) the minimum discharge current of the charge donor vehicle and the minimum charge current of the charge acceptor vehicle; (v) the maximum voltage of the charge donor vehicle to the maximum voltage of the DC-to-DC converter 140; (vi) the maximum voltage of the charge acceptor vehicle to the maximum voltage of the DC-to-DC converter 140; (vii) the minimum voltage of a charge donor vehicle to the minimum voltage of the DC-to-DC converter 140; and (viii) the minimum voltage of a charge acceptor vehicle to the minimum voltage of the DC-to-DC converter 140. In some implementations, comparing status information includes comparing [min, max] value ranges for power, current, and/or voltage to determine whether the ranges overlap.

The primary controller 120 is also configured to initiate charge transfer (e.g., transmission of electricity) from an electric vehicle that is connected to the control box 110 (via a charging cable 150-1 or 150-2) to the DC-to-DC converter 140 and from the DC-to-DC converter 140 to another electric vehicle (e.g., a different electric vehicle) that is also connected to the control box 110 (via a charging cable 150-1 or 150-2). Following the example provided above, after: (i) the first electric vehicle 160-1 has been designated as the charge donor vehicle, (ii) the second electric vehicle 160-2 has been designated as the charge acceptor vehicle, and (iii) the primary controller 120 has determined (e.g., verified) that the electric vehicles 160-1 and 160-2 can participate in a vehicle-to-vehicle charging process: the primary controller 120 initiates a charge transfer process from the first electric vehicle 160-1 to the second electric vehicle 160-2 via the charging cables 150-1 and 150-2, and via the DC-to-DC converter 140. In some implementations (e.g., when the first electric vehicle 160-1 has a different nominal voltage than the second electric vehicle 160-2), the primary controller 120 also controls (e.g., configures) the DC-to-DC converter 140 to change (e.g., convert) the voltage of the electricity transmitted from the first electric vehicle 160-1 to the second electric vehicle 160-2 so that electricity transmitted between the first electric vehicle 160-1 to the DC-to-DC converter 140 has a first nominal voltage and the electricity transmitted between the DC-to-DC converter 140 to the second electric vehicle 160-2 has a second nominal voltage that is different from the first nominal voltage. In some implementations, the primary controller 120 actively controls (e.g., actively configures) the DC-to-DC converter 140 throughout the entire vehicle-to-vehicle charging process.

The DC-to-DC converter 140 is a bi-directional DC-to-DC converter that can transmit electricity in either direction (e.g., from the first electric vehicle 160-1 to the second electric vehicle 160-2 or from the second electric vehicle 160-2 to the first electric vehicle 160-1). The bi-directional DC-to-DC converter 140 can step-up or step-down DC voltage from either side of the converter to the other side (e.g., it can increase or decrease the nominal voltage of electricity regardless of whether the electricity is being transmitted from the first electric vehicle 160-1 to the second electric vehicle 160-2 or from the second electric vehicle 160-2 to the first electric vehicle 160-1). Thus, the bi-directional DC-to-DC converter 140 allows the charging cables 150-1 and 150-2 to be attached to any electric vehicle (e.g., the electric vehicle 160-1 and 160-2) in any manner (e.g., in a manner that is agnostic regarding which electric vehicle is the charge donor and which electric vehicle is the charge acceptor, and in a manner that is agnostic regarding the relative voltages or relative nominal voltages of the electric vehicles).

In some implementations, such as when the first nominal voltage and the second nominal voltage are substantially similar (e.g., similar enough that a voltage conversion is not required), electricity is transmitted from the first electric vehicle to the second electric vehicle 160-2 via the DC-to-DC converter 140 without a change in voltage (e.g., the electricity is transmitted to the second electric vehicle 160-2 at the first nominal voltage). In some implementations, such as when the first nominal voltage and the second nominal voltage are substantially different (e.g., different enough that a voltage conversion is required), primary controller 120 configures the DC-to-DC converter 140 to convert electricity transmitted from the first electric vehicle to the second electric vehicle 160-2 from the first nominal voltage to the second nominal voltage.

The low voltage battery 190 is configured to provide power to the various components of the control box 110, such as the primary controller 120, the first SECC 130-1, the second SECC 130-2, the DC-to-DC converter 140, the first IMD 192-1, and the second IMD 192-2. The first IMD 192-1 is configured to monitor a resistance in the electrical circuit between the DC-to-DC converter 140 and the first battery 180-1, and provide an alert or interrupt the circuit (e.g., disrupt the transmission of power or electricity) if the first IMD 192-1 detects that the resistance in the circuit drops below a threshold resistance value (e.g., a safety resistance value). The second IMD 192-2 is configured to monitor a resistance in the electrical circuit between the DC-to-DC converter 140 and the second battery 180-2, and provide an alert or interrupt the circuit (e.g., disrupt the transmission of power or electricity) if the second IMD 192-2 detects that the resistance in the circuit drops below a threshold resistance value (e.g., a safety resistance value).

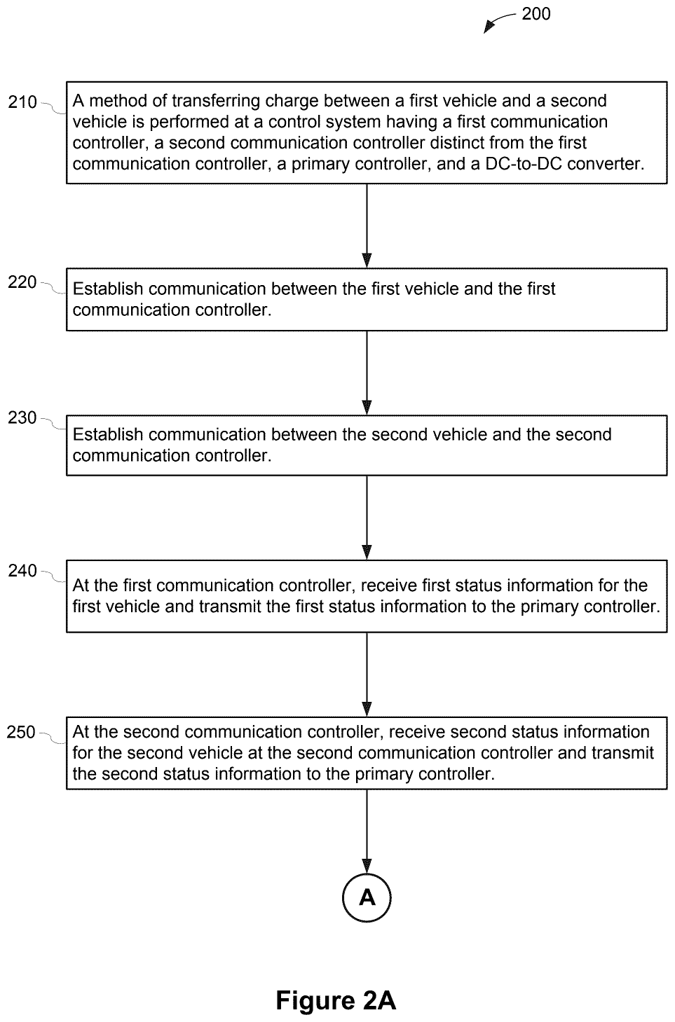

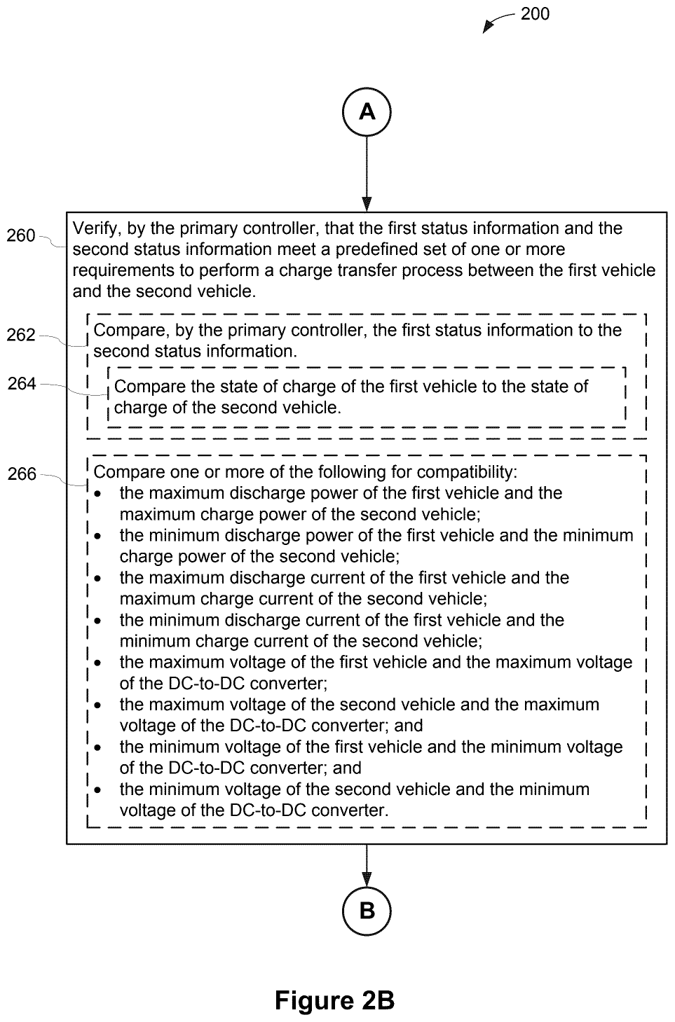

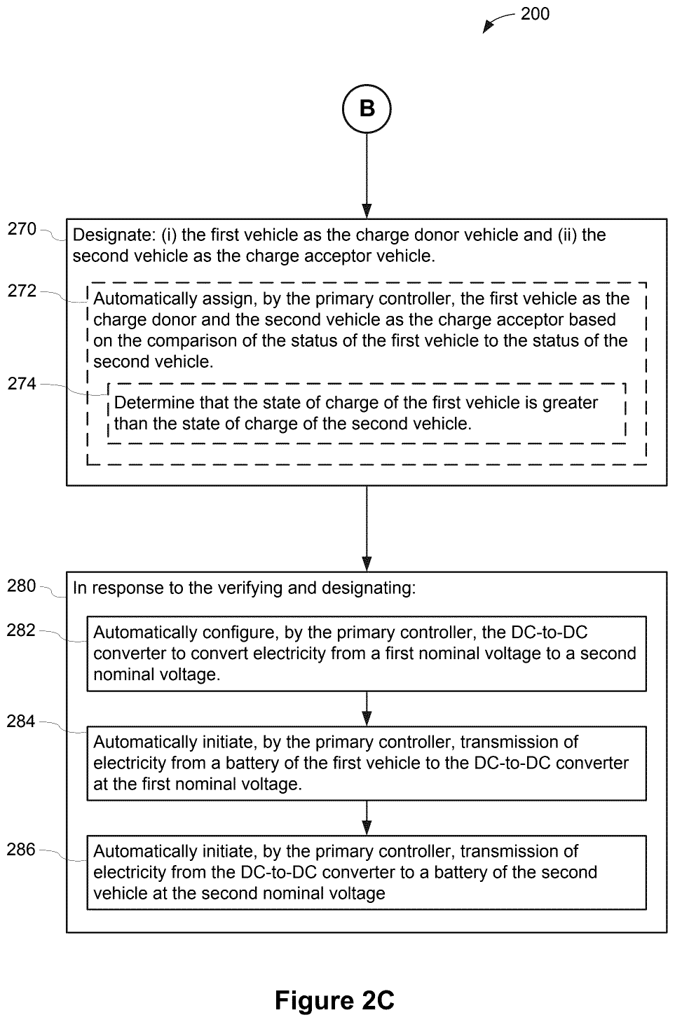

FIGS. 2A-2C provide a flowchart a method 200 for vehicle-to-vehicle charging in accordance with some implementations. The method 200 is performed (step 210) at a control system 100 that includes a first communication controller 130-1, a second communication controller 130-2 that is distinct from the first communication controller, a primary controller 120, and a DC-to-DC converter 140. The method 200 includes establishing (step 220) communication between a first vehicle 160-1 and the first communication controller 130-1, and establishing (step 230) communication between the second vehicle 160-2 and the second communication controller 130-2. The method 200 further includes: at the first communication controller 130-1, receiving (step 240) first status information for the first vehicle 160-1 and transmitting the first status information to the primary controller 120; and, at the second communication controller 130-2, receiving (step 250) second status information for the second vehicle 160-2 and transmitting the second status information to the primary controller 120. The method 200 also includes verifying (step 260), by the primary controller 120, that the first status information and the second status information meet a predefined set of one or more requirements to perform a charge transfer process between the first vehicle 160-1 and the second vehicle 160-2. The method 200 also includes designating (step 270) the first vehicle 160-1 as the charge donor vehicle and designating the second vehicle 160-2 as the charge acceptor vehicle. The method 200 further includes, in response (step 280) to the verifying and designating: automatically (e.g., without human intervention or without additional user action) configuring (step 282), by the primary controller 120, the DC-to-DC converter 140 to convert electricity from a first nominal voltage to a second nominal voltage; automatically (e.g., without human intervention or without additional user action) initiating (step 284), by the primary controller 120, transmission of electricity from the battery 180-1 of the first vehicle 160-1 to the DC-to-DC converter 140 at the first nominal voltage; and automatically (e.g., without human intervention or without additional user action) initiating (step 286), by the primary controller 120, transmission of electricity from the DC-to-DC converter 140 to the battery 180-2 of the second vehicle 160-2 at the second nominal voltage.

In some implementations, the first vehicle 160-1 has a different make and/or model from the second vehicle 160-2. In some implementations, the first vehicle 160-1 was manufactured by a different manufacturer than a manufacturer of the second vehicle 160-2.

In some implementations, the first vehicle 160-1 and the second vehicle 160-2 have a same make and/or model. In some implementations, the first vehicle 160-1 and the second vehicle 160-2 were manufactured by a same manufacturer.

In some implementations, the first nominal voltage is distinct (e.g., different from) the second nominal voltage such that the DC-to-DC converter 140 needs to up-convert or down-convert the voltage of the electricity being transmitted from the first vehicle 160-1 to the second vehicle 160-2. In some implementations, the first nominal voltage is substantially similar to (e.g. the same as) the second nominal voltage such that the DC-to-DC converter 140 can transmit the electricity the first vehicle 160-1 to the second vehicle 160-2 without needing to up-convert or down-convert the voltage of the electricity being transmitted.

In some implementations, the verifying step includes comparing (262), by the primary controller 120, the first status information of the first vehicle 160-1 to the second status information of the second vehicle 160-2. In some implementations, the comparing step includes comparing (step 264), by the primary controller 120, the state of charge of the first vehicle 160-1 to the state of charge of the second vehicle 160-2.

In some implementations, the verifying step includes comparing (step 266) one or more of the following for compatibility: (i) the maximum discharge power of the first vehicle 160-1 and the maximum charge power of the second vehicle; (ii) the minimum discharge power of the first vehicle 160-1 and the minimum charge power of the second vehicle 160-2; (iii) the maximum discharge current of the first vehicle 160-1 and the maximum charge current of the second vehicle 160-2; (iv) the minimum discharge current of the first vehicle 160-1 and the minimum charge current of the second vehicle 160-2; (v) the maximum voltage of the first vehicle 160-1 and the maximum voltage of the DC-to-DC converter 140; (vi) the maximum voltage of the second vehicle 160-2 and the maximum voltage of the DC-to-DC converter 140; (vii) the minimum voltage of the first vehicle 160-1 and the minimum voltage of the DC-to-DC converter 140; and (viii) the minimum voltage of the second vehicle 160-2 and the minimum voltage of the DC-to-DC converter 140. In some implementations, the verifying step includes comparing [min, max] ranges for power, current and/or voltage for the two vehicles (e.g., to verify that there are overlapping values between the two vehicles). In some implementations, the verifying step includes comparing [min, max] ranges for voltage for each of the vehicles (e.g., the first vehicle 160-1 and the second vehicle 160-2) and the DC-to-DC converter 140.

In some implementations, the designating step includes automatically (e.g., without human intervention or without additional user action) assigning (step 272), by the primary controller 120, the first vehicle 160-1 as the charge donor and the second vehicle 160-2 as the charge acceptor based on comparing the status of the first vehicle 160-1 to the status of the second vehicle 160-2. In some implementations, assigning the first vehicle 160-1 as the charge donor and the second vehicle 160-2 as the charge acceptor includes determining (step 274), by the primary controller 120, that the state of charge of the first vehicle 160-1 is greater than the state of charge of the second vehicle 160-2.

Turning now to some example implementations.

(A1) In one aspect, some implementations include a method for transferring charge between a first vehicle and a second vehicle. The method is performed at a control system that has a first communication controller, a second communication controller that is distinct from the first communication controller, a primary controller, and a DC-to-DC converter. The method includes establishing communication between the first vehicle and the first communication controller and establishing communication between the second vehicle and the second communication controller. The method also includes: at the first communication controller, receiving first status information for the first vehicle and transmitting the first status information to the primary controller; and at the second communication controller, receiving second status information for the second vehicle and transmitting the second status information to the primary controller. The method further includes verifying, by the primary controller, that the first status information and the second status information meet a predefined set of one or more requirements to perform a charge transfer process between the first vehicle and the second vehicle; and designating (i) the first vehicle as a charge donor vehicle and (ii) the second vehicle as a charge acceptor vehicle. The method also includes, in response to the verifying and designating: (a) automatically configuring, by the primary controller, the DC-to-DC converter to convert electricity from a first nominal voltage to a second nominal voltage; (b) automatically initiating, by the primary controller, transmission of electricity from a battery of the first vehicle to the DC-to-DC converter at the first nominal voltage; and (c) automatically initiating, by the primary controller, transmission of electricity from the DC-to-DC converter to a battery of the second vehicle at the second nominal voltage.

(A2) The method of A1, where the predefined set of one or more requirements includes a requirement for the charge donor vehicle to support bidirectional power flow.

(A3) The method of A1 or A2, where the battery of the second vehicle is configured to enable the powertrain of the second vehicle.

(A4) The method of any of A1-A3, where the battery of the first vehicle is configured to enable the powertrain of the first vehicle.

(A5) The method of any of A1-A4, where the electricity is transmitted from the first vehicle to the DC-to-DC converter via a first charging cable and the electricity is transmitted from the DC-to-DC converter to the second vehicle via a second charging cable that is distinct from the first charging cable.

(A6) The method of any of A1-A5, where the initiation of transmission of electricity from the battery of the first vehicle to the DC-to-DC converter and the initiation of transmission of electricity from the DC-to-DC converter to the battery of the second vehicle is performed by the primary controller without manual intervention.

(A7) The method of any of A1-A6, where the verifying includes comparing, by the primary controller, the first status information to the second status information; and the designating includes automatically assigning, by the primary controller, the first vehicle as a charge donor and the second vehicle as a charge acceptor based on the comparison of the status of the first vehicle to the status of the second vehicle.

(A8) The method of A7, where comparing the first status information to the second status information includes comparing the state of charge of the first vehicle to the state of charge of the second vehicle.

(A9) The method of A8, where assigning the first vehicle as the charge donor includes determining that the state of charge of the first vehicle is greater than the state of charge of the second vehicle.

(A10) The method of A9, where comparing the status of the first vehicle to the status of the second vehicle includes comparing one or more of the following for compatibility: (i) the maximum discharge power of the first vehicle and the maximum charge power of the second vehicle; (ii) the minimum discharge power of the first vehicle and the minimum charge power of the second vehicle; (iii) the maximum discharge current of the first vehicle and the maximum charge current of the second vehicle; (iv) the minimum discharge current of the first vehicle and the minimum charge current of the second vehicle; (v) the maximum voltage of the first vehicle and the maximum voltage of the DC-to-DC converter; (vi) the maximum voltage of the second vehicle and the maximum voltage of the DC-to-DC converter; (vii) the minimum voltage of the first vehicle and the minimum voltage of the DC-to-DC converter and (viii) the minimum voltage of the second vehicle and the minimum voltage of the DC-to-DC converter. In some implementations, the one or more comparisons include comparing [min, max] value ranges for power, current, and/or voltage between the two vehicles. In some implementations, the one or more comparisons include comparing [min, max] value ranges for voltage between each of the two vehicles and the DC-to-DC converter.

(A11) The method of any of A1-A7, where the first status information includes one or more of: the maximum discharge power of the first vehicle, the minimum discharge power of the first vehicle, the maximum discharge current of the first vehicle, the minimum discharge current of the first vehicle, the maximum voltage of the first vehicle, the minimum voltage of the first vehicle, the state of charge of the first vehicle, and a voltage of the battery of the first vehicle. The second status information includes one or more of: the maximum charge power of the second vehicle, the minimum charge power of the second vehicle, the maximum charge current of the second vehicle, the minimum charge current of the second vehicle, the maximum voltage of the second vehicle, the minimum voltage of the second vehicle, the state of charge of the second vehicle, and a voltage of the battery of the second vehicle.

(A12) The method of any of A1-A7, where the predefined set of one or more requirements includes one or more of: compatibility between the maximum discharge power of the first vehicle and the maximum charge power of the second vehicle; compatibility between the minimum discharge power of the first vehicle and the minimum charge power of the second vehicle; compatibility between the maximum discharge current of the first vehicle and the maximum charge current of the second vehicle; compatibility between the minimum discharge current of the first vehicle and the minimum charge current of the second vehicle; compatibility between the maximum voltage of the first vehicle and the maximum voltage of the DC-to-DC converter; compatibility between the maximum voltage of the second vehicle and the maximum voltage of the DC-to-DC converter; compatibility between the minimum voltage of the first vehicle and the minimum voltage of the DC-to-DC converter; and compatibility between the minimum voltage of the second vehicle and the minimum voltage of DC-to-DC converter. In some implementations, the one or more requirements include compatibility between [min, max] value ranges for power, current, and/or voltage between the two vehicles.

(B1) A control system includes a first communication controller, a second communication controller that is distinct from the first communication controller, a DC-to-DC converter, and a primary controller. The first communication controller is configured to receive first status information for a first vehicle and transmit the first status information to the primary controller. The second communication controller is configured to receive second status information for a second vehicle and transmit the second status information to the primary controller. The second vehicle is distinct from the first vehicle. The primary controller is configured to: (i) verify that the first status information and the second status information meet a predefined set of one or more requirements to perform a charge transfer process between the first vehicle and the second vehicle; (ii) designate: (a) the first vehicle as the charge donor vehicle and (b) the second vehicle as the charge acceptor vehicle; (iii) automatically configure the DC-to-DC converter to convert electricity from a first nominal voltage to a second nominal voltage; (iv) automatically initiate transmission of electricity from the battery of the first vehicle to the DC-to-DC converter at the first nominal voltage; and (v) automatically initiate transmission of electricity from the DC-to-DC converter to the battery of the second vehicle at the second nominal voltage.

(B2) The control system of B1, where the predefined set of one or more requirements includes a requirement for the charge donor vehicle to support bidirectional power flow.

(B3) The control system of B1 or B2, where the battery of the second vehicle is configured to enable the powertrain of the second vehicle.

(B4) The control system of any of B1-B3, where the battery of the first vehicle is configured to enable the powertrain of the first vehicle.

(B5) The control system of any of B1-B4, further including: (i) a first charging cable that is configured to transmit electricity from the first vehicle to the DC-to-DC converter, and (ii) a second charging cable that is configured to transmit electricity from the DC-to-DC converter to the second vehicle. The second charging cable is distinct from the first charging cable.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of transferring charge between a first vehicle and a second vehicle, the method comprising:
at a control system having a first communication controller, a second communication controller distinct from the first communication controller, a primary controller, and a DC-to-DC converter:
establishing communication between the first vehicle and the first communication controller;
establishing communication between the second vehicle and the second communication controller;
at the first communication controller, receiving first status information for the first vehicle and transmitting the first status information to the primary controller;
at the second communication controller, receiving second status information for the second vehicle and transmitting the second status information to the primary controller;
verifying, by the primary controller, that the first status information and the second status information meet a predefined set of one or more requirements to perform a charge transfer process between the first vehicle and the second vehicle;
designating (i) the first vehicle as a charge donor vehicle and (ii) the second vehicle as a charge acceptor vehicle;
in response to the verifying and designating:
automatically configuring, by the primary controller, the DC-to-DC converter to convert electricity from a first nominal voltage to a second nominal voltage;
automatically initiating, by the primary controller, transmission of electricity from a battery of the first vehicle to the DC-to-DC converter at the first nominal voltage; and
automatically initiating, by the primary controller, transmission of electricity from the DC-to-DC converter to a battery of the second vehicle at the second nominal voltage.

2. The method of claim 1, wherein the predefined set of one or more requirements includes a requirement for the charge donor vehicle to support bidirectional power flow.

3. The method of claim 1, wherein the battery of the second vehicle is configured to enable a powertrain of the second vehicle.

4. The method of claim 1, wherein the battery of the first vehicle is configured to enable a powertrain of the first vehicle.

5. The method of claim 1, wherein the electricity is transmitted from the first vehicle to the DC-to-DC converter via a first charging cable and the electricity is transmitted from the DC-to-DC converter to the second vehicle via a second charging cable that is distinct from the first charging cable.

6. The method of claim 1, wherein the initiation of transmission of electricity from the battery of the first vehicle to the DC-to-DC converter and the initiation of transmission of electricity from the DC-to-DC converter to the battery of the second vehicle is performed by the primary controller without manual intervention.

7. The method of claim 1, wherein:
the verifying includes comparing, by the primary controller, the first status information to the second status information; and
the designating includes automatically assigning, by the primary controller, the first vehicle as a charge donor and the second vehicle as a charge acceptor based on the comparison of the status of the first vehicle to the status of the second vehicle.

8. The method of claim 7, wherein comparing the first status information to the second status information includes comparing a state of charge of the first vehicle to a state of charge of the second vehicle.

9. The method of claim 8, wherein assigning the first vehicle as the charge donor includes determining that the state of charge of the first vehicle is greater than the state of charge of the second vehicle.

10. The method of claim 9, wherein comparing the status of the first vehicle to the status of the second vehicle includes comparing one or more of the following for compatibility:
a maximum discharge power of the first vehicle and a maximum charge power of the second vehicle;
a minimum discharge power of the first vehicle and a minimum charge power of the second vehicle;
a maximum discharge current of the first vehicle and a maximum charge current of the second vehicle;
a minimum discharge current of the first vehicle and a minimum charge current of the second vehicle;
a maximum voltage of the first vehicle and a maximum voltage of the DC-to-DC converter;
a maximum voltage of the second vehicle and a maximum voltage of the DC-to-DC converter;
a minimum voltage of the first vehicle and a minimum voltage of the DC-to-DC converter; and
a minimum voltage of the second vehicle and a minimum voltage of the DC-to-DC converter.

11. The method of claim 1, wherein:
the first status information includes one or more of: a maximum discharge power of the first vehicle, a minimum discharge power of the first vehicle, a maximum discharge current of the first vehicle, a minimum discharge current of the first vehicle, a maximum voltage of the first vehicle, a minimum voltage of the first vehicle, a state of charge of the first vehicle, and a voltage of the battery of the first vehicle; and
the second status information includes one or more of: a maximum charge power of the second vehicle, a minimum charge power of the second vehicle, a maximum charge current of the second vehicle, a minimum charge current of the second vehicle, a maximum voltage of the second vehicle, a minimum voltage of the second vehicle, a state of charge of the second vehicle, and a voltage of the battery of the second vehicle.

12. The method of claim 1, wherein the predefined set of one or more requirements includes one or more of:
compatibility between a maximum discharge power of the first vehicle and a maximum charge power of the second vehicle;
compatibility between a minimum discharge power of the first vehicle and a minimum charge power of the second vehicle;
compatibility between a maximum discharge current of the first vehicle and a maximum charge current of the second vehicle;
compatibility between a minimum discharge current of the first vehicle and a minimum charge current of the second vehicle;
compatibility between a maximum voltage of the first vehicle and a maximum voltage of the DC-to-DC converter;
compatibility between a maximum voltage of the second vehicle and a maximum voltage of the DC-to-DC converter;
compatibility between a minimum voltage of the first vehicle and a minimum voltage of the DC-to-DC converter; and
compatibility between a minimum voltage of the second vehicle and a minimum voltage of the DC-to-DC converter.

13. A control system comprising:
a first communication controller;
a second communication controller distinct from the first communication controller;
a DC-to-DC converter; and
a primary controller, wherein:
the first communication controller is configured to receive first status information for a first vehicle and transmit the first status information to the primary controller;
the second communication controller is configured to receive second status information for a second vehicle and transmit the second status information to the primary controller;
the second vehicle is distinct from the first vehicle; and
the primary controller is configured to:
verify that the first status information and the second status information meet a predefined set of one or more requirements to perform a charge transfer process between the first vehicle and the second vehicle;
designate: (i) the first vehicle as a charge donor vehicle and (ii) the second vehicle as a charge acceptor vehicle;
automatically configure the DC-to-DC converter to convert electricity from a first nominal voltage to a second nominal voltage;
automatically initiate transmission of electricity from a battery of the first vehicle to the DC-to-DC converter at the first nominal voltage; and
automatically initiate transmission of electricity from the DC-to-DC converter to a battery of the second vehicle at the second nominal voltage.

14. The control system of claim 13, wherein the predefined set of one or more requirements includes a requirement for the charge donor vehicle to support bidirectional power flow.

15. The control system of claim 13, wherein the battery of the second vehicle is configured to enable a powertrain of the second vehicle.

16. The control system of claim 13, wherein the battery of the first vehicle is configured to enable a powertrain of the first vehicle.

17. The control system of claim 13, further comprising:
a first charging cable configured to transmit electricity from the first vehicle to the DC-to-DC converter; and
a second charging cable configured to transmit electricity from the DC-to-DC converter to the second vehicle, wherein the second charging cable is distinct from the first charging cable.
